(19) United States
(12) Patent Application Publication
(10) Pub. No.: US 2016/0167726 A1
(43) Pub. Date: Jun. 16, 2016

(54) BICYCLE SADDLE

(71) Applicant: Jackson C. Dudley, II, Ocala, FL (US)

(72) Inventor: Jackson C. Dudley, II, Ocala, FL (US)

(21) Appl. No.: 14/965,774

(22) Filed: Dec. 10, 2015

Related U.S. Application Data
(60) Provisional application No. 62/090,007, filed on Dec. 10, 2014.

(51) Int. Cl. B62J 1/06; B62J 1/00

(52) U.S. Cl. CPC B62J 1/06; B62J 1/007

(57) ABSTRACT

A saddle for peddle operated devices such as bicycles, tricycles, stationary bikes comprises a pair of rider supports sized to support the regions of the ischium and upper femur of the rider, each rider support being pivotally mounted to a normally horizontal mounting member (i.e., an “axel”) so as to provide a limited amount of free tilting movement about a common axis of rotation thus enabling unobstructed pedaling motion of the legs. The unique curvature of the rider supports allows the rider to maintain contact with the seat during a peddling cycle (rather than being thrown forward), maintain orientation of the rider's sit bones above the rider support axis of rotation during the peddling cycle and keep the rider's hips in balance during the peddling cycle.

### RELATED APPLICATION

This application claims the benefit of U.S. Provisional Application No. 62/090,007 filed Dec. 10, 2014 and entitled, Bicycle Saddle.

### FIELD OF THE INVENTION

The present invention pertains to a rider support assemblies for pedal-operated devices such as bicycles, bicycles, stationary bikes and the like, and more particularly to those of the split seat or “noseless” variety.

### BACKGROUND OF THE INVENTION

A bicycle saddle, often called a seat, is one of three contact points on a pedal operated device, the others being the pedals and the handlebars. Although riding an upright bicycle is a common form of exercise employed not only for enjoyment but for improving the cardiovascular system, cycling often imparts prolonged pressure on the rider's sub-perineum, more commonly referred to as the crotch area, resulting in reduced blood flow and possible nerve damage for both men and women.

Heretofore, a myriad of what are referred to as “anatomically correct” seat designs have been developed for reducing crotch pressure and improving rider comfort and support while mounted on pedal operated devices such as bicycles and stationary bikes. Examples of such designs include the cutaway saddles and noseless saddles. Cutaway saddles resemble regular saddles in their design, but with the middle part cut out to reduce pressure on the perineum among men. Noseless saddles, sometimes also referred to as “split seat” saddles are characterized generally by a pair of side-by-side rider support members each adapted for independent pivotal rotation about a common horizontal axis of rotation. They are basically two separate saddles next to each other, with one smaller “saddle” per buttock. The purpose of such a design is to avoid pain, numbness and other more serious side effects which stem from use of conventional bicycle seats by shifting the support and consequent pressure away from the sub-perineum to the relatively larger surface areas of the lower buttocks and upper legs which are better suited to bear the rider's weight when seated.

One example of a noseless saddle is described in U.S. Pat. No. 4,387,925 issued to Barker et al. in 1983, which teaches a split seat design wherein the pair of rider supports are shaped to generally conform to the shape of a human body in the region of the ischium and upper femur. The support portions have a limited amount of free tilting movement about the axis of a horizontal mounting member to enable unobstructed pedaling motion of the legs. While the Barker split seat attempted to obviate the above-mentioned side effects associated with conventional bicycle seats, it failed to achieve any significant degree of market success. This may be due in part to what may be considered a design flaw, namely that the shape and orientation of each rider support relative to its axis of rotation are such that, when pivoted during the peddling cycle, they cause the rider's hips to be thrown off their horizontal axis and further throw the rider's torso in a forward direction off of the support. It would, therefore, be ideal to have known in the art a noseless saddle design that provides the intended improved rider support and comfort while maintaining the rider's pelvis in a balanced position and the rider's seat in contact with the underlying supports therefore.

All patents, patent applications, provisional applications, and publications referred to or cited herein, or from which a claim for benefit of priority has been made, are incorporated herein by reference in their entirety to the extent they are not inconsistent with the explicit teachings of this specification.

### SUMMARY OF THE INVENTION

According to one aspect of the present invention, there is provided a saddle for peddle operated devices such as bicycles, tricycles, stationary bikes and the like (together hereinafter referred to herein simply as “bike” or “bicycle”), the saddle comprising a pair of rider supports sized to support the regions of the ischium and upper femur of the rider, each rider support being pivotally mounted to a normally horizontal mounting member (i.e., an “axel”) so as to provide a limited amount of free tilting movement about a common axis of rotation thus enabling unobstructed pedaling motion of the legs. A preferred embodiment of the subject invention comprises a pair of rider supports each pivotally mounted to an axel in parallel relationship so as to permit unobstructed pedaling motion of the legs when mounted to a peddle operated device; each rider support sharing a common axis of rotation; each rider support including a center portion disposed directly above said axis of rotation for supporting engagement with a seat bone of a rider, a fore-portion depending forwardly from said center portion and sized and shaped for supporting engagement with an upper leg portion of a rider, and a downwardly curved aft-portion depending rearwardly from said center portion; whereby the downwardly curved shape of the aft-portion preventing forward displacement of the rider's seat bones during a peddling motion thus maintaining orientation of the rider's sit bones above the axis of rotation during the peddling cycle and further maintaining the rider's hips in balance with one another.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the included abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a primary object of the subject invention to provide an improved noseless saddle for pedal-operated devices such as bicycles, tricycles, stationary bikes and the like, said saddle having a pair of independently pivotable rider support members each adapted to conform to the anatomy of the rider's buttocks and upper thigh areas and to yield to the movement of these areas during the peddling motion to provide a more comfortable riding experience.

It is also a primary object of the subject noseless saddle to obviate pain, numbness and other more serious side effects which stem from use of conventional bicycle saddles by shifting the support and consequent pressure away from the sub-perineum or “crotch” area to the relatively larger surface areas of the lower buttocks and upper legs which are better suited to bear the rider's weight when seated.

Another object of the present invention is to obviate the above side effects of conventional saddles while simultaneously permitting the rider to maintain a proper riding position without throwing the pelvis off balance laterally (i.e., uneven sit bone heights).

Still another object of the subject improved noseless saddle is to better accommodate large people, including those suffering from obesity, who are unable to tolerate riding on conventional saddles.

Yet another object of the subject invention is to provide a noseless saddle seat that is simple in design and therefore capable of rapid construction and assembly at a relatively low cost.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is front elevation view of a first embodiment of a noseless saddle of the subject invention portions of which are depicted in phantom view to better illustrate the design of various components thereof;

FIG. 2 is a side elevation view of the noseless saddle of FIG. 1;

FIG. 3 is front elevation view of a noseless saddle of the subject invention having alternative means for limiting the degree of rotation of each rider support;

FIG. 4 is a side elevation view of the noseless saddle of FIG. 3;

FIG. 5 is a side elevation view of a noseless saddle of the subject invention with a rider mounted thereon and illustrating the pivotal rotation of a rider support;

FIG. 6 is a perspective view of a noseless saddle of the subject invention with a mounted rider in phantom view to better illustrate how the lower buttocks and upper thighs are supported without pressure on the lower perineum;

FIG. 7 is a perspective view of a noseless saddle of the subject invention including a fabric panel mounted between the pair of rider supports; and

FIG. 8 is a perspective view of a noseless saddle of the subject invention including a bonnet-style cover mounted over both rider supports to provide a flexible fabric support panel therebetween.

### DETAILED DESCRIPTION OF THE PREFERRED EMBODIMENT

It should be clearly understood at the outset like reference numerals are intended to identify the same structural elements, portions or surfaces consistently throughout the several drawings herein, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, any reference to the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. The terms “seat” and “saddle” are used interchangeably herein without distinction unless specifically stated to the contrary.

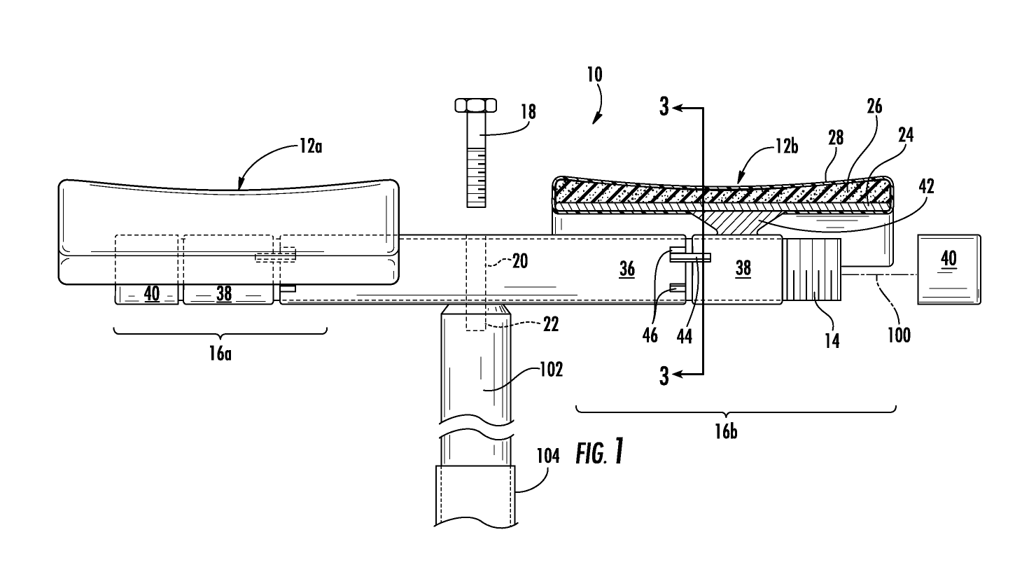

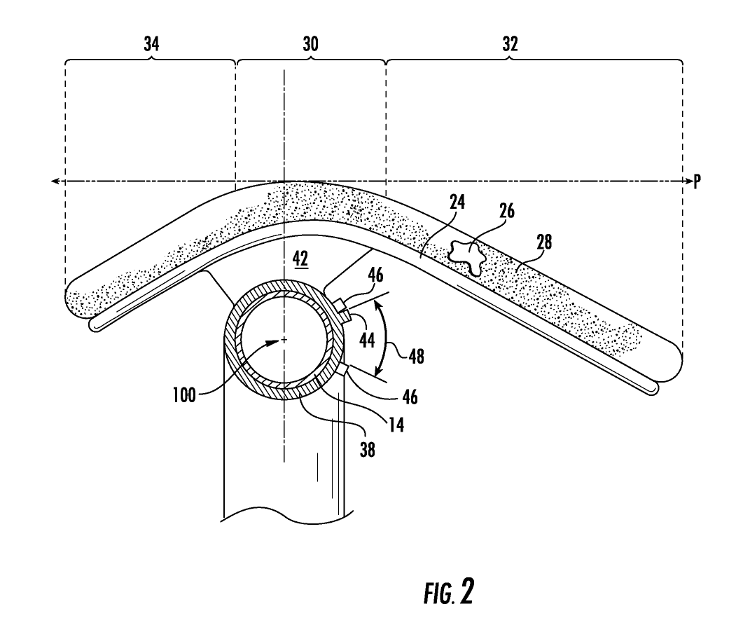

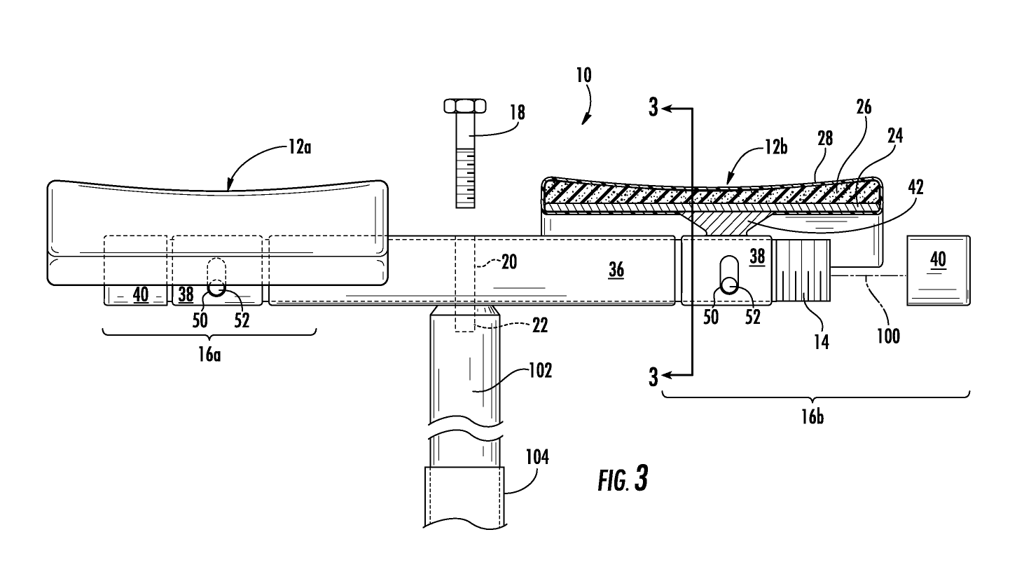

Reference is first made to FIGS. 1 and 2 in which there are illustrated front elevation and side elevation views of a preferred embodiment of the subject noseless saddle designated generally by reference numeral 10. Saddle 10 is comprised of three primary components, namely a pair of rider supports 12a,12b, at least one normally horizontal mounting member or “axel” 14 to which the rider supports are mounted, and pivot means comprising a pair of pivot assemblies 16a,16b for pivotally mounting each rider support to one of the at least one axel 14. Each saddle 10 of the subject invention further includes mounting means for removably mounting the saddle to the bicycle generally, and more specifically to the seatpost 102 which in turn is slidably mounted within the seat tube 104 of the bicycle frame (not shown). For the purpose of clarity, the seatpost 102, also referred to as a seatpin, saddlepole, saddle pillar or saddle pin is the tube that extends upwards from the seat tube 104 of the bicycle frame to the saddle. The seatpost is typically capable of slidable adjustment within the seat tube to raise or lower the saddle to a desired height above the bicycle frame. While not a component of the subject invention, it should be appreciated that the subject saddles are suitable for use with virtually any seatpost type, including plain, micro-adjustable, integrated, aero, suspension, pivotal, seatmast type, dropper type and interlock type. A myriad of mounting methods and hardware may be employed and are known to those skilled in the art. For the sake of simplicity, the mounting means for mounting saddle 10 to seatpost 102 as illustrated in FIGS. 1 and 2 is comprised of a carriage bolt 18 having a shaft portion sized for insertion through an aperture 20 transversely disposed through the midpoint of axel 14 and into a reciprocally threaded chamber 22 of seatpost 102, thereby securing axel 14 in perpendicular relation to the terminal end of the seatpost.

Rider supports 12a,12b are each sized to support the regions of a rider's buttock (including seat bone which is also referred to as a “sit bone” and more technically as an “ischial tuberosity”) and upper thigh. Each rider support 12a,12b is comprised of a rigid and generally convex base plate 24 or “shell” which creates the shape of the saddle. The shell can be made from a variety of materials, preferably but not essentially a molded piece of plastic, such as nylon, or of carbon fiber. Each rider support 12a,12b further includes some form of padding 26 on the top of base plate 24 such as a dosed cell foam, gel or gel-foam which in turn may optionally be covered by cover 28 consisting of spandex, vinyl, artificial leather or leather, for instance.

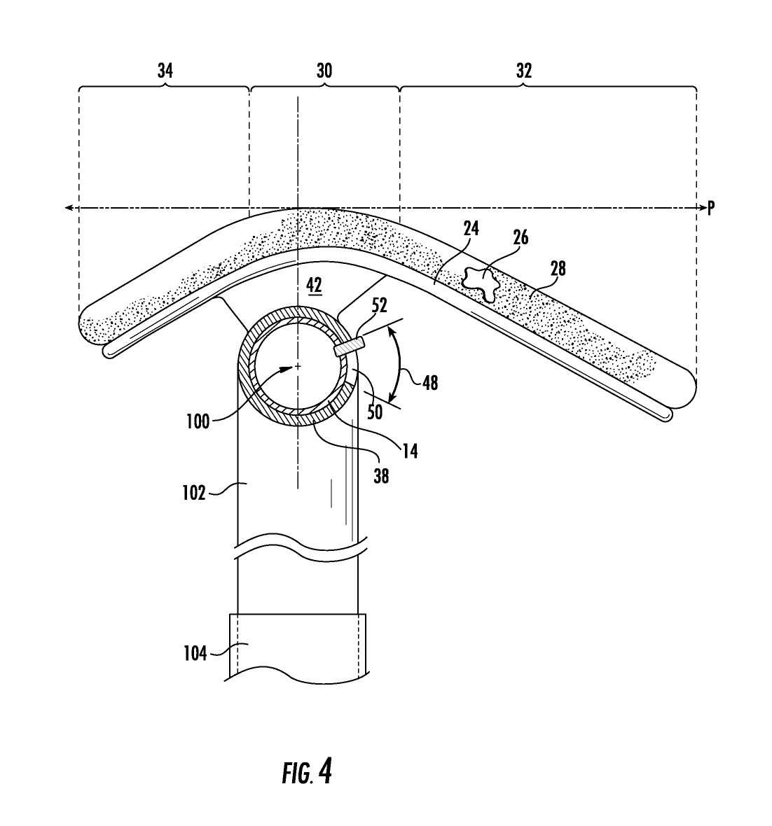

As best observed by reference to FIGS. 2 and 4, each rider support 12a,12b is generally curved in shape having a curved center portion 30, a downwardly depending (relative to center portion 30) fore-portion 32 and a downwardly depending (relative to center portion 30) downwardly curved aft-portion 34. Center portion 30 is situated above axel 14 such that its apex is in general vertical alignment with the longitudinal axis of axel 14 which is the axis of rotation 100 of each rider support 12a,12b. Center portion 30 supports a seat bone SB of the rider and may include a detent or cupped area to receive the seat bone therein, or may otherwise be shaped to facilitate proper rider positioning on the rider support 12a, 12b. In one embodiment, fore-portion 32 is more planar in shape and elongated to provide support to the upper thigh region of the rider. In a preferred embodiment, each rider support 12a,12b will normally rest in a forwardly rotated position such that fore-portion 32 is rotated generally downward and aft-portion 34 is rotated generally upward. Fore-portion 32 can be cupped in cross-section to conform to the shape of a rider's upper thigh as best observed upon reference to FIG. 1. In one embodiment, aft-portion 34 is relatively shorter than fore-portion 32 as it is not intended to bear a significant percentage of the rider's weight.

Each rider support 12a,12b is pivotally mounted to the normally horizontal mounting member 14 via a pivot assembly 16a,16b to provide a limited amount of free tilting movement of the support saddle about a common axis of rotation thus enabling unobstructed pedaling motion of the legs. A single horizontal mounting member 14 may be employed for this purpose (as shown), or each rider support may be mounted to a separate horizontal mounting member provided they share the same longitudinal axis 100 which will serve as the axis of rotation of both rider supports 12a,12b. Each pivot assembly 16a,16b is comprised of a bearing 38 sized for slidable reception on, and partial pivotal rotation about, axel 14. An end cap or ring 40 is removably mounted to the distal end of axel 14 to retain bearing 38 in place and to prevent its axial displacement from axel 14. Each rider support 12a, 12b is mounted to its corresponding bearing 38 via a support-bearing interface such as a connection bracket 42.

In order to control the degree of rotation of each bearing 38 and their counterpart rider supports 12a, 12b about axis 100 of axel 14, seat rotation limiting means are provided. In a preferred embodiment, each bearing 38 has a no greater than 90 degree freedom of rotation about the axel upon which it is mounted. A range of approximately 40 degrees to 80 degrees is preferred with 60 degrees of rotation being ideal. In the embodiment illustrated in FIGS. 1 and 2, rotation limiting means are comprised of a post 44 fixedly mounted to bearing 38 in cantilevered fashion so as to overlap a portion of an adjacent sleeve 36 fixedly mounted to axel 14, said sleeve 36 including a pair of stops 46 extending radially from its outer surface; one above post 44 and one below. As may be readily appreciated, stops 46 limit the degree of travel of post 44 (and thus of bearing 38) along arc of rotation 48 to the desired degree of rotation as determined by the distance between stops 46. In another embodiment, seat rotation limiting means is comprised of a slot 50 disposed through bearing 38 and in communication with the underlying axel 14, and a peg 52 fixedly mounted at one end to bearing 38 and extending radially into or through slot 50. Slot 50 is sized to provide no greater than 90 degrees (and preferably between 40 and 80 degrees) of rotation of peg 52 about axis of rotation 100 along the circumference of bearing 38. Accordingly, each bearing 38 and its counterpart rider support 12a,12b has a limited degree of rotation within the above described range of motion. Those skilled in the art will appreciate that numerous other means of controlling the degree of rotation of each rider support may alternately be employed.

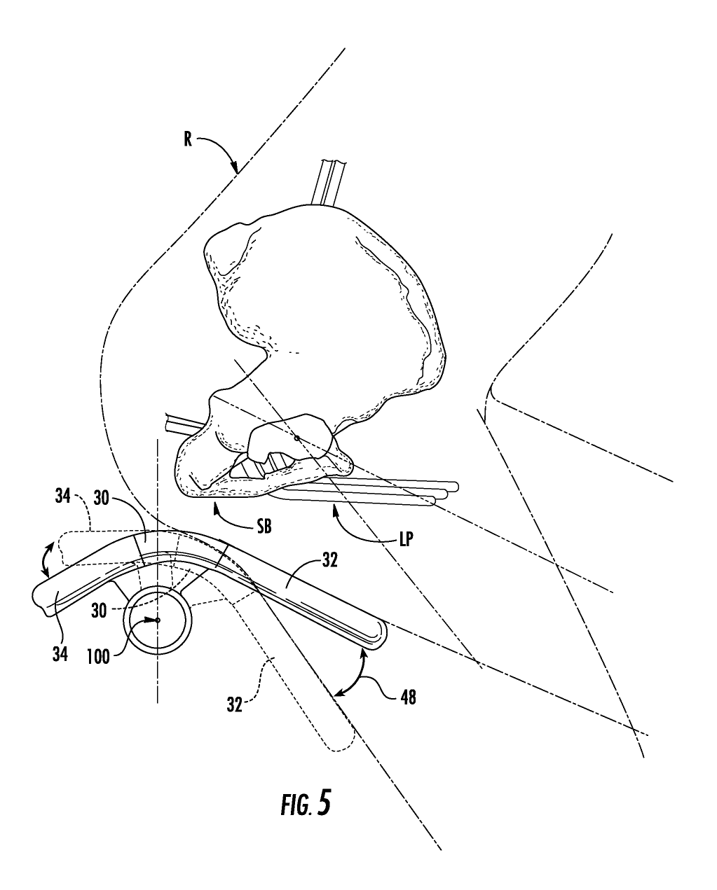

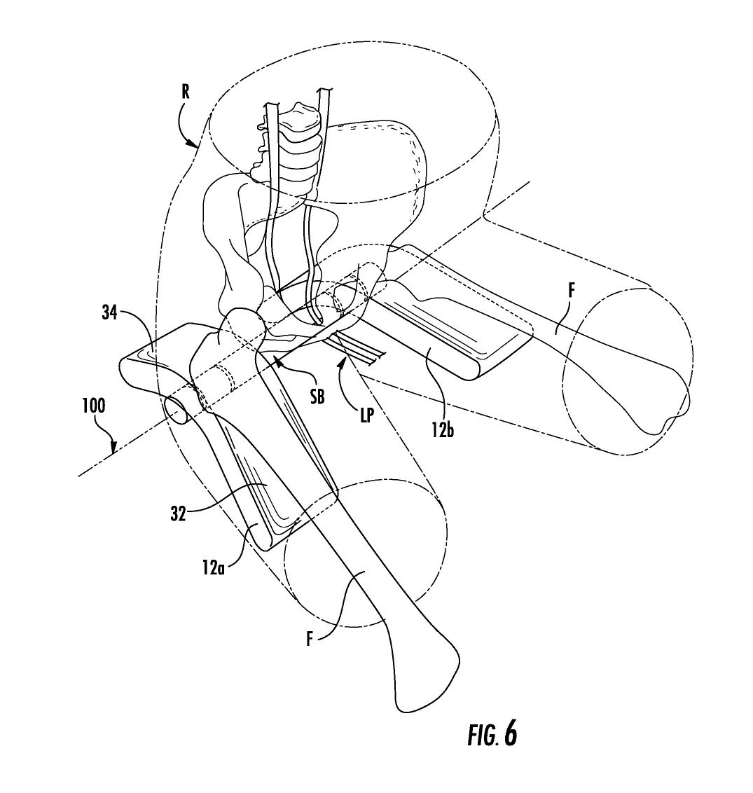

Referring to FIGS. 2, 4 and 5, note that the apex of center portion 30 of each rider support is oriented above axis of rotation 100, fore-portion 32 thus being positioned in front of the axis of rotation and an aft-portion 34 being positioned behind said axis of rotation. A key feature of the subject saddle 10 is that the seat rotation limiting means and downwardly curved shape of the aft-portion 34 of each rider support 12a,12b prevent the aft-portion from rotating above center portion 30 thereby preventing the rider's hips from being thrown forward. Note that aft-portion 34 of each rider support 12a,12b depends downwardly from center-portion 30 which supports a sit bone of the rider. When fore-portion 32 is tilted downwardly during a peddling stroke, the aft portion 34 will not rotate upwardly above center portion 30 or past a normally horizontal plane P in contact with the apex of each rider support 12a,12b in the region of center portion 30. The downwardly depending and downwardly curved design of aft-portion 34 relative to center portion 30 prevents aft-portion from lifting the rider's buttock off plane P as the underlying support 12a,12b rotates about its axis of rotation 100. Accordingly, the rider's hips are prevented from being thrown forward and instead remain balanced during the peddling cycle and the rider's sit bones remain oriented above the axis of rotation.

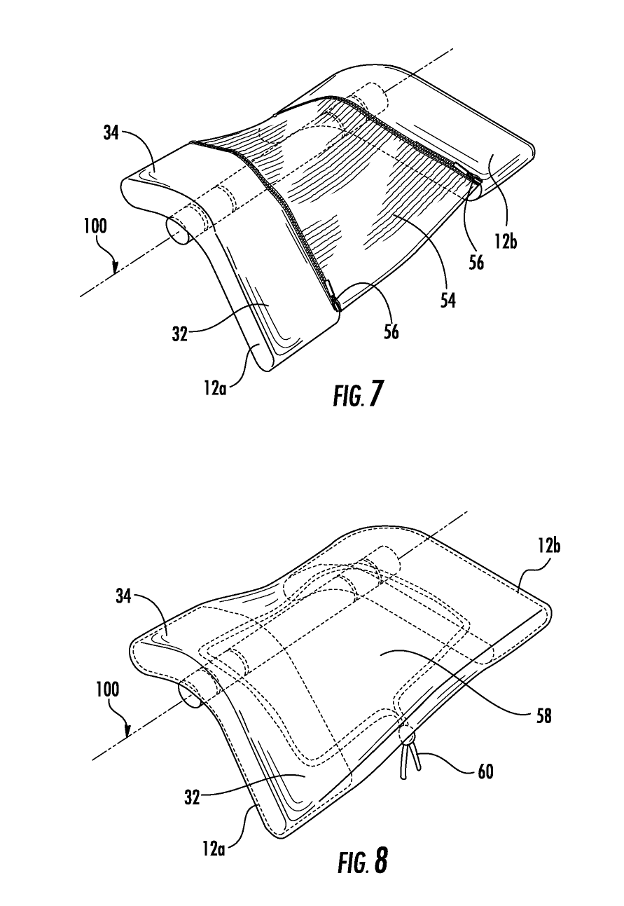

Because rider supports 12a,12b are normally spaced approximately two inches apart from one another creating a gap, it is possible for male genitalia, or loose skin or fatty tissue of overweight riders, to fall into the gap when the rider is seated on the apparatus. Such tissue can potentially be pinched or otherwise expose the rider to discomfort as the supports 12a,12b move in reciprocating fashion while peddling. To obviate this problem, another embodiment of the subject invention (FIG. 7) further includes a fabric panel 54 disposed between and bridging the gap between rider supports 12a,12b so as to support rider tissue and prevent it from falling between the rider supports. The fabric panel 54 is preferably but not essentially constructed of a stretch fabric of either the d-way stretch variety or more preferably the 4-way stretch variety such as spandex or elastane (widely branded as “Lycra”). The panel may be removably secured to each rider support using various attachment means 56 such as hook and loop tape, zippers or the like. In another embodiment (FIG. 8), a bonnet-style cover 58 is stretched over the adjoining rider supports 12a,12b and secured with a drawstring or other suitable fastening means 60. Cover 58 is preferably but not essentially constructed of the same stretch fabric as is fabric panel 54. Cover 60 and panel 54 also serve to prevent sweat from soiling the equipment below the rider supports, and may be removed for laundering.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A saddle for peddle operated devices, comprising: a pair of rider supports each pivotally mounted to an axel in parallel relationship so as to permit unobstructed pedaling motion of the legs when mounted to a peddle operated device; each rider support sharing a common axis of rotation; each rider support including a center portion disposed directly above said axis of rotation for supporting engagement with a seat bone of a rider, a fore-portion depending forwardly from said center portion and sized and shaped for supporting engagement with an upper leg portion of a rider, and a downwardly curved aft-portion depending rearwardly from said center portion; whereby the downwardly curved shape of the aft-portion preventing forward displacement of the rider's seat bones during a peddling motion thus maintaining orientation of the rider's sit bones above the axis of rotation during the peddling cycle and further maintaining the rider's hips in balance with one another.

2. The saddle of claim 1, further including seat rotation limiting means for limiting the degree of rotation of said pair of rider supports about said axel.

3. The saddle of claim 1, wherein said pair of rider supports are each pivotally mounted to the same axel.

4. The saddle of claim 1, wherein said pair of rider supports are each pivotally mounted to a different axel sharing a common longitudinal axis.

5. The saddle of claim 1, further including a stretchable fabric panel disposed between said pair of rider supports.
